(19) United States
(12) Patent Application Publication
(10) Pub. No.: US 2011/0162336 A1
(43) Pub. Date: Jul. 7, 2011

(54) Filter for Removing Particles from Gas Flows

(75) Inventor: Jørgen Bech Poulsen, Nakskov (DK)

(73) Assignee: TDC FILTER MANUFACTURING, INC., Niles, IL (US)

(21) Appl. No.: 12/945,561

(22) Filed: Nov. 12, 2010

(30) Foreign Application Priority Data
Dec. 11, 2009 (DK) PA 2009 01308

(51) Int. Cl. B01D 46/00

(52) U.S. Cl. 55/486

(57) ABSTRACT

A filter for particle cleaning of impurities in gas flows must be compact and also as effective as possible, including having a pressure drop as low as possible.

According to the invention, such filters are composed of three ring-shaped and pleated filter elements, comprising an outermost (4), a middle (5) and an innermost filter element (6) said filters being held together at the inlet side (1, 12) and outlet side (9, 10) of the filter, respectively.

Hereby, gas may be supplied to the exterior of the filter as well as to the spaces (8) between the innermost filter element (6) and the middle filter element (5), and this gas will be discharged (14) both from the central filter chamber (15) and from the chamber (17) between the middle filter element (5) and the outermost filter element (4).

### THE PRIOR ART

The invention relates to a filter for removing particles from gas flows, such as from air, smoke and residual gases, said filter being constructed as a so-called cassette filter, in which filter elements extend between the inlet side and the outlet side of the filter.

So-called cassette filters are known in various embodiments. As indicated by the name, they are constructed as cassettes which may be inserted into a reception chamber, so that they may be mounted and removed, as needed.

The filter element itself normally comprises a plurality of filters, each of which has the shape of a box which is open toward the outlet side. The rear side of the box faces toward the inlet side of the filter.

These filter boxes are normally arranged upright, so that the filters extend vertically, and so that a plurality of filter boxes, e.g. four, constitute the overall filter area of the cassette.

However, these filters have a limited inlet or suction area, as this will correspond to the sum of the individual filter chambers, viz. the bottom plus the two sides of each box.

This area cannot be increased without changing the outer dimensions of the cassette. To this should be added that these cassette filters have a relatively high pressure loss because of the high filter load, which limits the flow.

### THE OBJECT OF THE INVENTION

It is the object of the invention to remedy these drawbacks of known filters, and this is achieved according to the invention in that the filter element itself comprises a ring-shaped, innermost filter which forms a central filter chamber, a further ring-shaped middle filter around the innermost filter, as well as an outermost ring-shaped filter extending around the middle filter, said filters being secured at the inlet side and the outlet side of the filter, respectively.

A filter is formed in this surprisingly simple manner, whose inlet area is larger than correspondingly dimensioned known filters, as the filter area forms annular inlet channels in the form of two ring-shaped filter inlets. This means that the pressure loss through the filter is lower than in corresponding known cassette filters.

Moreover, this filter area may be increased readily by making the ring-shaped filter elements longer—i.e. increasing the distance between the inlet side and the outlet side of the filter.

When, as stated in claim 2, the filter elements extend obliquely, the filter area is larger than if they extended straight from the inlet side to the outlet side. To this should be added the greater self-cleaning which the obliquely extending filter elements involve because of the higher degree of precipitation.

When, as stated in claim 3, the inlet side is configured both as a ring-shaped inlet chamber and as a chamber extending along the outer side of the filter, and the discharge is allowed to take place via a central and ring-shaped chamber, it is ensured that the filter has a great capacity and a low pressure loss.

When, as stated in claim 4, the individual filters are pleated, the greatest possible filter area will be achieved, and moreover a relatively rigid and thus stable filter shape which may be cleaned easily.

When, as stated in claim 5, the outermost filter layer is provided with openings along its lower side on the outlet side, the filter will be capable of discharging, draining itself, when liquid is discharged through these openings. In case of moist flows, the filter will thus be able to operate without problems.

When, as stated in claim 6, the outlet side has a quadrangular shape, it will be possible to insert the filter corresponding to known cassette filters.

Finally, it is expedient, as stated in claim 7, to use the filter, as it involves a larger filter area in a restricted space, and thereby a greater capacity and a lower pressure loss.

### THE DRAWING

An example of an embodiment of the filter according to the invention will be described more fully below with reference to the drawing, in which

FIG. 1 shows the filter seen toward the inlet side,

FIG. 2 shows the filter seen toward the outlet side,

FIG. 3 shows a section through the filter seen in a direction in FIG. 2, and

FIG. 4 shows a section, indicated by a circle in FIG. 2, of a lowermost part of the outermost filter and the frame.

### DESCRIPTION OF AN EXEMPLARY EMBODIMENT

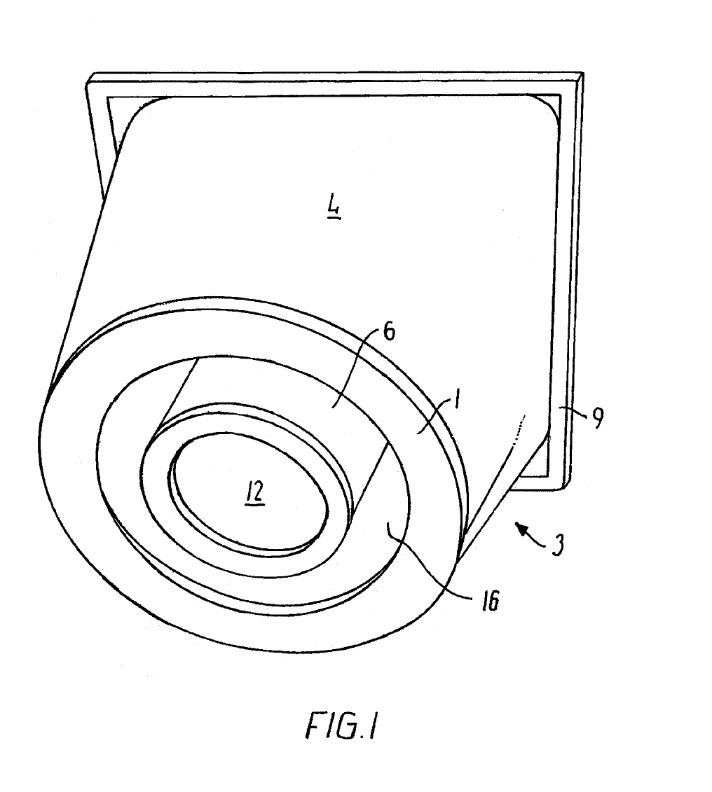

FIG. 1 shows an example of a cassette filter according to the invention seen toward its inlet side—i.e. the side to which the gas flow is conveyed. The drawing shows how the inlet side and the outlet side are configured, viz. partly as a circular side, partly as a quadrangular side.

The inlet side has two gas inlets, viz. partly a ring-shaped slot 16, partly the inlet from the outside, as indicated by an arrow 3. This latter gas flow passes through the outermost filter 4, as will be described later.

As regards the dimensions of the cassette filter, it may be stated that with a largest diameter of the ring 1 on the inlet side of about 45 cm, a distance between the inlet side and the outlet side, i.e. the depth of the filter, of about 45 cm, and an outlet side edge of about 59 cm, the effective filter area will constitute 21 m².

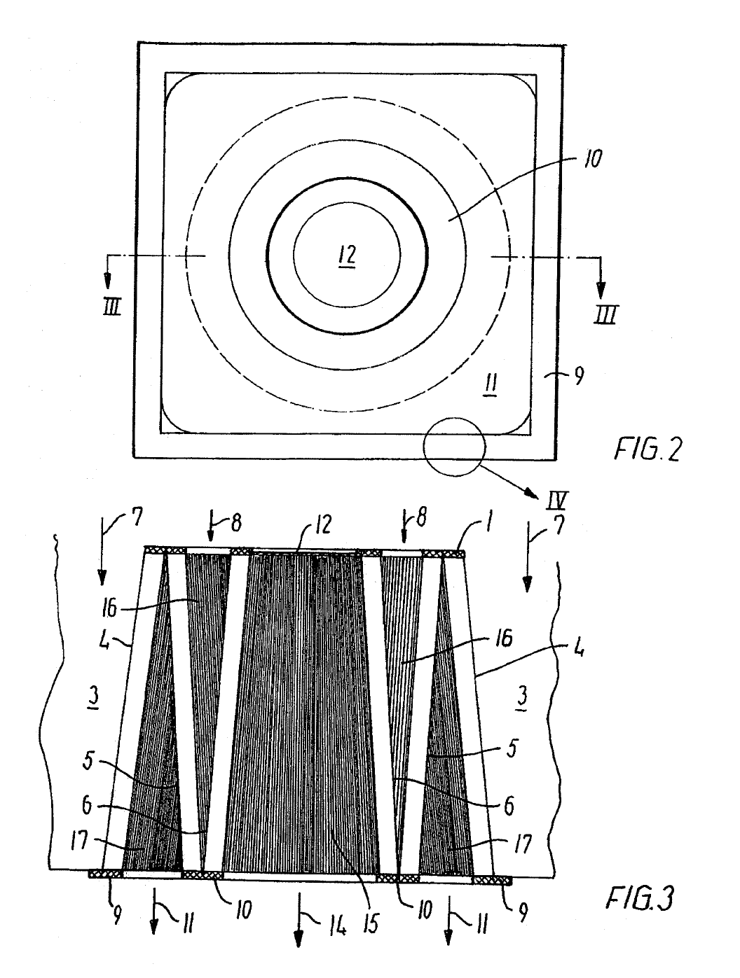

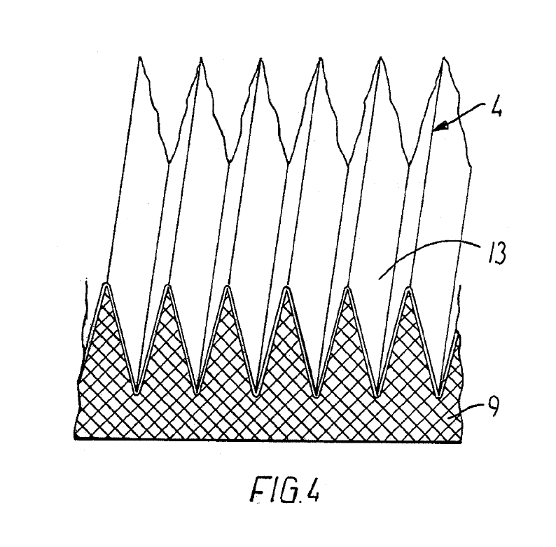

The individual filter elements will now be described with reference to FIG. 3, which is a longitudinal section of the filter shown in FIG. 2.

The top of FIG. 3 shows the inlet side where gas flows 7 and 8 are indicated by arrows.

As shown, the individual filter elements are ring-shaped and comprise an outer filter element 4, a middle filter element 5 and an innermost filter element 6.

These three filter elements are made of a generally known filter cloth, and they are pleated in their entire extent in the longitudinal direction as well as in the annular direction. This in order to make the filter area as large as possible and also to impart a suitable rigidity and thereby dimensional stability to the elements.

As will likewise appear from FIG. 3, the outermost filter element 4 and the innermost filter element 6 extend obliquely outwards between the inlet side and the outlet side, while the middle filter element 5 extends obliquely in-wards.

The purpose of this is to create chambers which serve as sluice chambers on the outlet side of the elements, which are so large as to provide an even and unobstructed gas flow through the filter elements.

The inlet gas flow 8 through the ring-shaped inlet slot is conveyed through the innermost filter element 6 into the central chamber 15. The inlet to this central chamber 5 is blocked or closed by means of a cover or a plate 12, which extends at the end of the innermost filter element 6.

The outer gas flow 7 is conveyed through the outermost filter element 4 and into the outermost chamber 17.

Then, the gas flows are discharged via the ring-shaped outlet slots 11 and the central opening 14.

To hold the filter elements together at the ends, an adhesive is used in a known manner as a binding and sealing means between the ring 1 on the inlet side and the ring 10 and the frame 9 on the outlet side.

To drain the filter, openings 13 may be provided between the pleats of the outermost filter 4, as shown in the sectional view in FIG. 4. This may be done by blocking the supply of adhesive, or by subsequently removing the adhesive.

Openings 13 may be provided on the lower side of the entire filter element at the frame 9 or only a portion of it, depending on the need for draining.

The filter may be manufactured in a manner corresponding to known filters, and, therefore, they are not very expensive to produce, but the capacity is considerably greater because of the larger filter area, the efficiency is higher because of the obliquely extending filter elements and thereby the high degree of self-cleaning because of precipitation, and last but not least because of the small pressure loss to which the flow is subjected at the cleaning in the filter.

1. A filter for removing particles from gas flows extending between the inlet side and the outlet side of the filter, comprising: a ring-shaped innermost filter which forms a central filter chamber, a further ring-shaped middle filter around the innermost filter, as well as an outermost ring-shaped filter extending around the middle filter, said innermost, middle and outermost filters being secured at the inlet side and the outlet side of the filter, respectively.

2. A filter according to claim 1, wherein the outermost filter and the innermost filter extend obliquely outwards from the inlet side to the outlet side, while the middle filter extends obliquely inwards from the inlet side to the outlet side.

3. A filter according to claim 1, wherein the outermost filter and the middle filter are held together at the inlet side to form a ring-shaped end, while the innermost filter is held together around the centre of the inlet side in the form of a circular closure, and the outermost filter is held together at the outlet side to form an outer edge, while the middle filter and the innermost filter are held together in a ring-shaped part which constitutes the end of the central filter chamber.

4. A filter according to claim 1, wherein the individual filters are pleated in their entire extent, length and circumference between their inlet side and outlet side.

5. A filter according to claim 1, wherein openings are provided along the lower side of the outermost filter on the outlet side, said openings being formed by removal of or omission of adhesive between the pleats along the lower edge.

6. A filter according to claim 1, characterized in that wherein the inlet side has a circular extent, while the outlet side has a quadrangular extent.

7. A filter according to claim 1 wherein the gas to be filtered is supplied to partly to the wedge-shaped chamber between the middle filter and the innermost filter, partly to the chamber outside the outermost filter, following which the air passes through the middle filter and the innermost filter and is discharged via the central filter chamber and via the outermost chamber, respectively.
